(19) United States
(12) Patent Application Publication
(10) Pub. No.: US 2012/0045167 A1
(43) Pub. Date: Feb. 23, 2012

(54) Multi-Tier Micro-Ring Resonator Optical Interconnect System

(75) Inventors: Martin Julien, Laval (CA); Robert Brunner, Montreal (CA)

(73) Assignee: TELEFONAKTIEBOLAGET L M ERICSSON (PUBL), Stockholm (SE)

(21) Appl. No.: 12/861,185

(22) Filed: Aug. 23, 2010

(51) Int. Cl. G02B 6/125; G02B 6/26

(52) U.S. Cl. 385/14; 264/1.25

(57) ABSTRACT

Systems and methods according to these exemplary embodiments provide for optical interconnection using dual micro-ring resonators in a multilayer structure. Multi-wavelength optical signals can be redirected on a wavelength-by-wavelength basis, or larger, from input ports on a first layer to output ports on a second layer of an optical device.

### TECHNICAL FIELD

The present invention relates generally to telecommunications systems and in particular to optical crossbar switches and associated methods.

### BACKGROUND

Communications technologies and uses have greatly changed over the last few decades. In the fairly recent past, copper wire technologies were the primary mechanism used for transmitting voice communications over long distances. As computers were introduced the desire to exchange data between remote sites became desirable for many purposes. The introduction of cable television provided additional options for increasing communications and data delivery from businesses to the public. As technology continued to move forward, digital subscriber line (DSL) transmission equipment was introduced which allowed for faster data transmissions over the existing copper phone wire infrastructure. Additionally, two way exchanges of information over the cable infrastructure became available to businesses and the public. These advances have promoted growth in service options available for use, which in turn increases the need to continue to improve the available bandwidth for delivering these services, particularly as the quality of video and overall amount of content available for delivery increases.

One promising technology that has been introduced is the use of optical fibers for telecommunication purposes. Optical fiber network standards, such as synchronous optical networks (SONET) and the synchronous digital hierarchy (SDH) over optical transport (OTN), have been in existence since the 1980s and allow for the possibility to use the high capacity and low attenuation of optical fibers for long haul transport of aggregated network traffic. These standards have been improved upon and today, using OC-768/STM-256 (versions of the SONET and SDH standards respectively), a line rate of 40 gigabits/second is achievable using dense wave division multiplexing (DWDM) on standard optical fibers.

As these (and other) optical networks are being deployed, there is an increasing need to provide efficient solutions for switching and routing information within and between such networks. Currently, specialized optical switches are available for large optical networks, which specialized switches are typically extremely expensive since they are developed for specific types of core networks. In addition to providing basic switching functionality, these types of specialized optical switches also typically provide value-added features such as accounting, rate-limiting, etc.

As optical technology is maturing, the cost related to its use is decreasing. Also, as networking and communication systems are imposing greater requirements associated with capacity and sustainability, optical-based solutions are becoming more attractive for system architecture designs. However, smaller networking systems typically have different requirements than those of large optical networks. In other words, specific solutions might have to be developed on a system basis, rather than on a more generic network basis. While expensive solutions might be affordable for some networks, they might not be acceptable at a node level.

In order to build networking systems based on optical technologies, there is a need to provide simple, scalable, reliable and affordable solutions for optical switches and crossbars. The current available technologies for providing optical crossbars and switches typically require the use of mirrors and MEMS technology. Depending on the implementation, such optical switching solutions can be extremely complicated and expensive, especially when they are built for controlling traffic on networks, not for smaller-scale systems.

Moreover, the usage of mirrors and MEMS technology in optical switches brings with it certain potential drawbacks. For example, in such optical switches, mirrors are provided on printed circuit boards (PCBs) or other electronic devices. While mirrors can be used to redirect optical signals, they lack the capability of selectively reflecting only a specific optical wavelength without the help of a specific optical filter. Additionally, the use of mirrors requires more space on a PCB or an electronic device, apart from the fact that mirrors might be required to move in order to allow the optical signals to be reflected in the required direction. For the mirrors in an optical switch to move, MEMS technology can be used, which can lead to simple or complex solutions, depending on the flexibility with which the mirrors have to move. Typically, since MEMS technology is basically a means to move extremely small components or devices mechanically, there exists an inherent operation/repair risk related to limitations and problems that can arise because of such mechanical movements.

Other alternatives for building optical switches can be based on a mix of technology choices. For example, there optical switches can be designed which include conversions between the optical and the electrical domains, which could allow the use of traditional layer 2 switches, such as Ethernet switches. While systems could be built relatively easily using those technologies, such solutions are expensive in terms of energy consumption, space and components. Ideally, efficient solutions should avoid any transitions from the optical domain.

Accordingly, it would be desirable to provide optical switches or crossbars which overcome the aforedescribed drawbacks.

### SUMMARY

Systems and methods according to these exemplary embodiments provide for optical interconnection using dual micro-ring resonators in a multilayer structure. Multi-wavelength optical signals can be redirected on a wavelength-by-wavelength basis, or larger, from input ports on a first layer to output ports on a second layer of an optical device. Among other advantages and benefits, exemplary embodiments provide for a dense optical device without the need for mirrors or mechanically moving parts.

According to one exemplary embodiment, an optical interconnect system includes a multilayer optical interconnect device having a plurality of input ports for receiving optical signals, a plurality of input waveguides, each connected to one of the plurality of input ports, for guiding the optical signals, a plurality of output ports, a plurality of output waveguides, each connected to one of the plurality of output ports, wherein the plurality of input ports and input waveguides are disposed on a first layer of the multilayer optical interconnect device, wherein the plurality of output ports and output waveguides are disposed on a second layer of the multilayer optical interconnect device, wherein the plurality of input waveguides and the plurality of output waveguides are disposed on the first and second layers in an orthogonal relationship, and at least one dual micro-ring resonator disposed at each of a plurality of intersections between one of the plurality of input waveguides and one of the plurality of output waveguides, each of the at least one dual micro-ring resonator being configured to redirect an optical wavelength associated with the optical signals from the one of the plurality of input waveguides to the one of the plurality of output waveguides.

According to another exemplary embodiment, a method for conveying optical wavelengths in a multilayer optical interconnect includes the steps of: receiving optical signals at a plurality of input ports, conveying the optical signals via a plurality of input waveguides, each connected to one of the plurality of input ports, redirecting, at each of a plurality of intersections between one of the plurality of input waveguides and one of a plurality of output waveguides, an optical wavelength associated with a respective intersection from the one of the plurality of input waveguides to the one of the output waveguides, and conveying redirected optical signals via the plurality of output waveguides to a plurality of output ports, wherein the plurality of input ports and input waveguides are disposed on a first layer of the multilayer optical interconnect device, wherein the plurality of output ports and output waveguides are disposed on a second layer of the multilayer optical interconnect device, wherein the plurality of input waveguides and the plurality of output waveguides are disposed in an orthogonal relationship, and wherein the step of redirecting is performed by at least one dual micro-ring resonator disposed at each intersection between the one of the plurality of input waveguides and the one of the plurality of output waveguides.

According to yet another embodiment, a method for manufacturing an optical interconnect system includes the steps of: manufacturing a multilayer optical interconnect device by: providing a plurality of input ports on a first layer of a substrate, forming a plurality of input waveguides, each connected to one of the plurality of input ports, on the first layer of the substrate, providing a plurality of output ports on a second layer of the substrate, forming a plurality of output waveguides, each connected to one of the plurality of output ports, on the second layer of the substrate in an orthogonal relationship relative to the plurality of input waveguides, and providing at least one dual micro-ring resonator disposed at each of a plurality of intersections between one of the plurality of input waveguides and one of the plurality of output waveguides, each of the at least one dual micro-ring resonator being configured to redirect an optical wavelength associated with the optical signals from the one of the plurality of input waveguides to the one of the plurality of output waveguides.

### BRIEF DESCRIPTION OF THE DRAWINGS

The accompanying drawings illustrate exemplary embodiments, wherein:

FIG. 1 depicts an exemplary optical interconnect device;

FIG. 2 illustrates a dual micro-ring resonator at an intersection of an input waveguide and an output waveguide;

FIG. 3 shows how the structure in FIG. 2 can be used to redirect a multi-wavelength optical signal toward different output ports;

FIG. 4 illustrates a dual micro-ring resonator at an intersection of an input waveguide and an output waveguide portions of which are disposed on different levels of an optical interconnect device;

FIG. 5 depicts a three-port, two layer optical interconnect device according to an exemplary embodiment;

FIG. 6 shows a portion of an optical interconnect device having a modified output layer according to an exemplary embodiment;

FIG. 7 illustrates a three-port, two layer optical interconnect device according to the exemplary embodiment of FIG. 6;

FIG. 8 illustrates an 80 port optical interconnect device according to an exemplary embodiment;

FIGS. 9 and 10 show various configurations in which optical interconnect devices can be stacked or connected according to exemplary embodiments;

FIG. 11 is a flowchart depicting a method for conveying optical signals according to an exemplary embodiment; and

FIG. 12 is a method flowchart illustrating a method for manufacturing an optical interconnect device according to an exemplary embodiment.

### DETAILED DESCRIPTION

The following detailed description of the exemplary embodiments refers to the accompanying drawings. The same reference numbers in different drawings identify the same or similar elements. Also, the following detailed description does not limit the invention. Instead, the scope of the invention is defined by the appended claims.

According to exemplary embodiments a reconfigurable optical crossbar is provided based on dual-micro-ring resonator technology. Dual micro-ring resonator technology is used in the reconfigurable optical crossbar according to these exemplary embodiments to transfer an optical wavelength from one waveguide to another waveguide. Using such dual micro-ring resonator technology, exemplary embodiments selectively transfer a specific wavelength between an input port and an output port of the reconfigurable optical crossbar. The dual-micro-ring resonators within the optical crossbar can be dynamically configured in order to extract the required wavelength, allowing an optical crossbar according to these exemplary embodiments to also be reconfigurable dynamically.

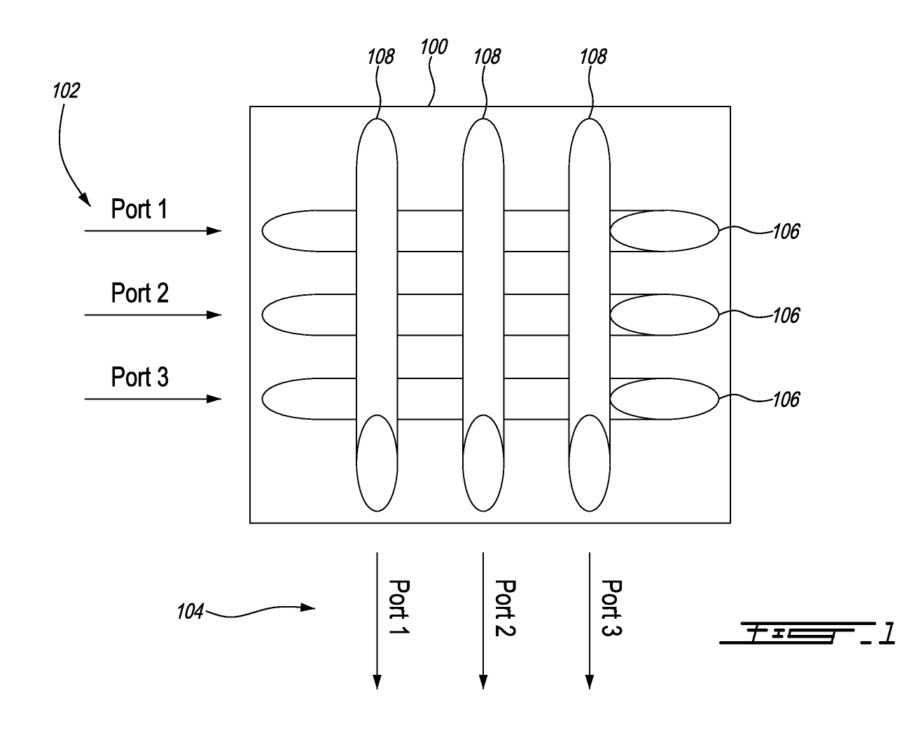

An optical switch or crossbar can be seen as a component with several optical ports connected thereto. Each port can either be a port used to only receive, to only send, or receive and send optical channels. For example, in FIG. 1, the optical switch/crossbar 100 can be seen as having three incoming ports 102 and three outgoing ports 104. As suggested by the phrase wave division multiplex (WDM), each port 102, 104 can carry several different optical channels. Each optical channel is characterized by a unique optical wavelength of the light. Similarly, each of the input waveguides 106 and output waveguides 108, which are arranged in a crossbar pattern, can also carry several different optical channels. In order to efficiently use dual micro-ring resonators in the optical switch or crossbar 100 according to these exemplary embodiments, the waveguides 106, 108 are based on Planar Light wave Circuit (PLC) technology, i.e., either using glass, fiber, polymer, etc. For clarity, exemplary embodiments can be implemented in an optical switch, an optical crossbar, optical router or other optical crossconnect devices, which latter phrase is used herein generically to include optical switches, optical crossbars and other optical devices.

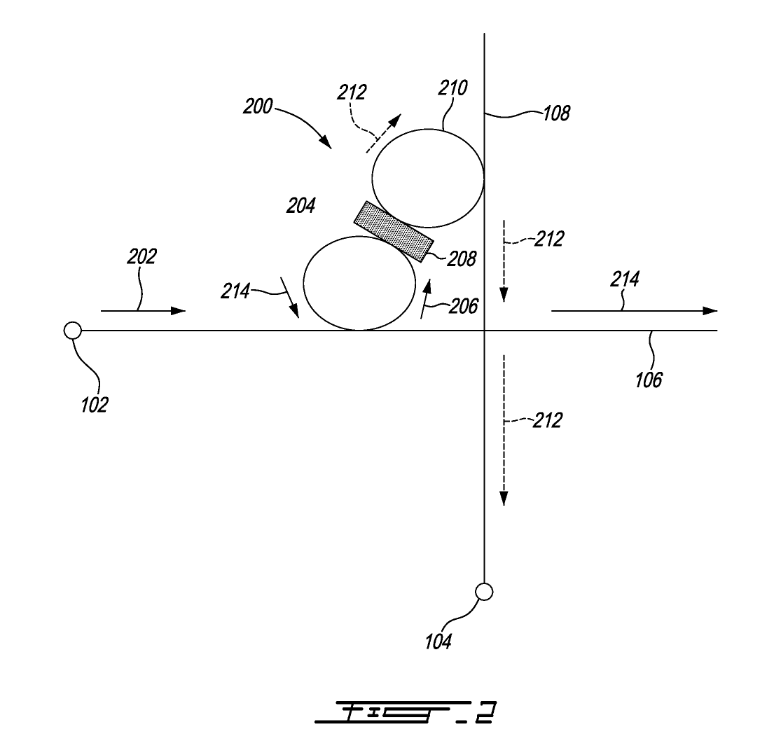

As seen in FIG. 2, instead of stationary or movable mirrors, exemplary embodiments use dual micro-ring resonators 200 to selectively extract a specific optical channel, or wavelength, from an input waveguide 106, and to redirect that optical channel or wavelength towards an outgoing port 104. Therein, light (denoted by arrow 202) travels from input port 102 through waveguide 106 to a first micro-ring or loop 204. All of the light 202 enters the first micro-ring 204 as denoted by arrow 206. However light associated with a single, predetermined optical channel or wavelength is transferred from the first micro-ring 204 to the second micro-ring 208 by coupler 208, such that it circulates in a second micro-ring 210 as denoted by dotted arrow 212. The extracted wavelength light 212 exits the second micro-ring 210 at its connection to output port waveguide 108 and is conveyed to the output port 104 which is connected to that waveguide 108 as shown by the additional dotted arrows 212. Meanwhile, the remaining light (depicted by arrow 214) which is not transferred by coupler 208, continues around the first micro-ring 204 and exits that micro-ring 204 to continue along input waveguide 106. Thus, light 214 contains one or more wavelengths other than the predetermined wavelength which was extracted by the dual micro-ring resonator 200.

The dual micro-ring resonator 200 is set to extract a particular optical wavelength from the light which is forced to enter the first micro-ring 204. This setting can either be fixed or may be dynamically configurable by tuning the micro-ring. Tuning can be accomplished by heating (or cooling) the micro-ring or by varying an electric field applied across the micro-ring, either of which will vary the index or refraction associated with the material from which the micro-ring is made. Depending on the type of material, e.g., polymers or semiconductors, used to build the micro-ring resonators 200, it can be extremely fast to dynamically reconfigure the micro-ring resonators. Additional details relating to micro-ring resonators can be found, for example, in the article entitled “Vertically Coupled Microring Resonators Using Polymer Wafer Bonding”, to Absil et al., published in IEEE Photonics Technology Letters, Vol. 13, No. 1, January 2001, pp. 49-51, the disclosure of which is incorporated here by reference.

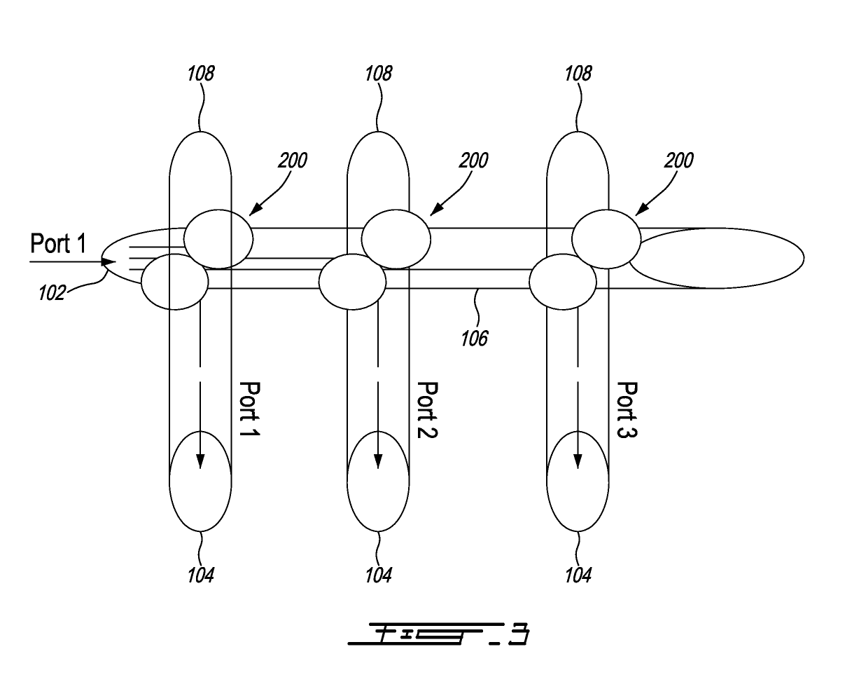

From the foregoing, it will be appreciated that a dual micro-ring resonator 200 can be configured to transfer one specific wavelength from an input waveguide 106 to an output waveguide 108. For example, assuming that an input port 102 carries three different optical channels, it thus becomes possible according to exemplary embodiments to transfer each of those optical channels to a specific output port 104 by placing a dual micro-ring resonator 200 at each of a plurality of intersections of input and output waveguides as shown, for example, in FIG. 3. Therein, a different optical wavelength is extracted by each of the three dual micro-ring resonators such that a different optical channel is redirected to each of the three output ports 104. Note, however that, assuming there is only one micro-ring resonator 200 placed at each intersection between an input waveguide 106 and an output waveguide 108, a maximum of one incoming wavelength per input port 102 can be redirected towards a specific output port 104. Alternatively, multiple dual micro-ring resonators could be placed at one or more of the intersections between input waveguides 106 and output waveguides 108 in order to enable the redirection of multiple optical channels or wavelengths from an input port 102 to an output port 104.

Many current dual-micro-ring resonator technologies involve manufacturing a dual-micro-ring resonator on a single layer of a PCB or an electronic device. However, developing an optical crossbar or switch 100 based on a single layer of dual-micro-ring resonators 200 would require a considerable amount of space on a device or PCB. Thus, according to exemplary embodiments, it is instead advantageous to develop the dual-micro-ring resonator 200 to be used in optical crossbars or switches on two separate layers of, e.g., a PCB, instead of a single layer. According to exemplary embodiments, the two layers can be disposed on top of each other which, among other things, avoids potential manufacturing difficulties which would be associated with manufacturing such an optical crossbar on a single layer PCB. Moreover, each of the two layers according to exemplary embodiments implements one of the two micro-rings in each dual micro-ring resonator 200.

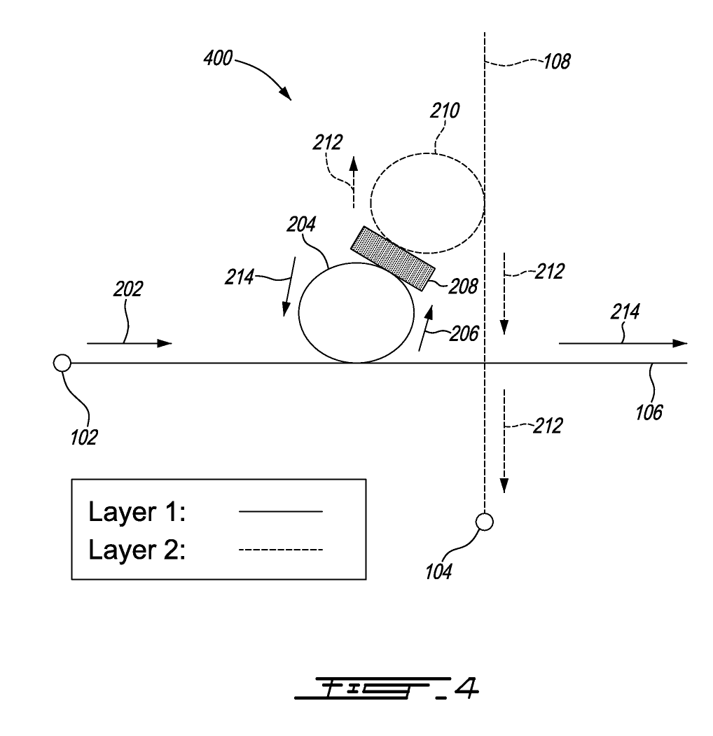

An example of such a two layer implementation of a dual micro-ring resonator 400 according to an exemplary embodiment is shown in FIG. 4. Therein, the same reference numbers are used as in FIG. 2, and this portion of an optical crossbar according to an exemplary embodiment operates in the same manner as described above with respect thereto. However in the embodiment of FIG. 4, the elements displayed in solid lines are disposed on a first layer, e.g., of a PCB, while those displayed in dotted lines are disposed on a second layer, e.g., below the first layer. Thus, in the example of FIG. 4, the second micro-ring 210, the output waveguide 108 and the output port 104 are disposed on the second (lower) layer, while the remaining elements are disposed on the first (upper) layer. In this regard note that the dual micro-ring resonator 400 is disposed in a region proximate an intersection between the orthogonally disposed input waveguide 206 and output waveguide 108. Thus, in this context, the term “intersection” as used herein refers to a region near where an input waveguide 106 overlays (or underlays) an output waveguide 108.

The selection of which optical elements in an optical crossbar or switch to dispose on which of the two layers also represents another aspect of these exemplary embodiments. For example, all of the incoming waveguides 106 can be located on one layer, while all the outgoing waveguides 108 can be located on the other layer, although this is not a requirement of these embodiments. Having two layers also makes it possible to direct the optical channels orthogonally between the incoming waveguides 106 and the outgoing waveguides 108. This exemplary orthogonal layout greatly simplifies scalability of optical devices according to exemplary embodiments, as more ports can be added based on a composition of simple modules implementing a limited number of ports. Since a dual-micro-ring resonator 400 is built on two separate layers, it is also possible to avoid the crosstalk loss which is usually involved as the number of wavelengths increases. A similar design can be used on both of the two layers.

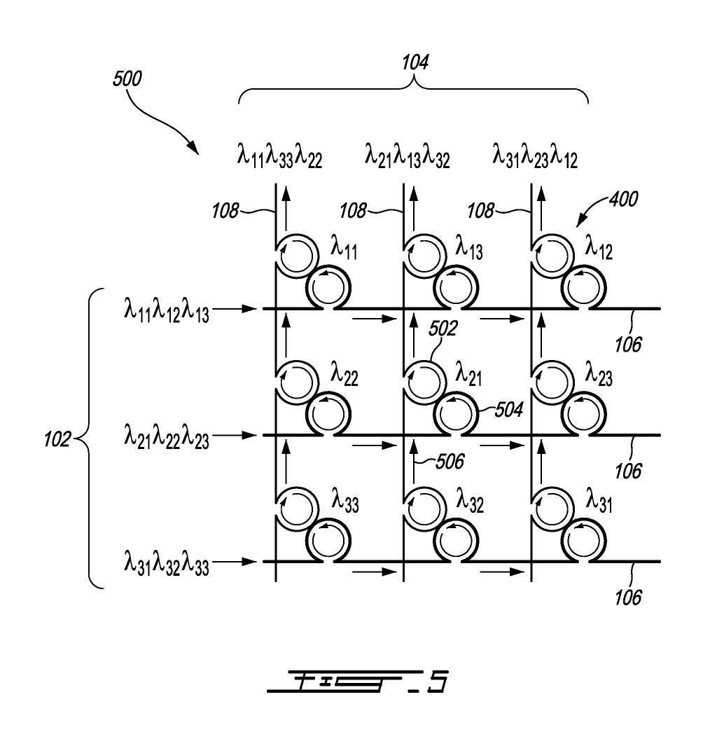

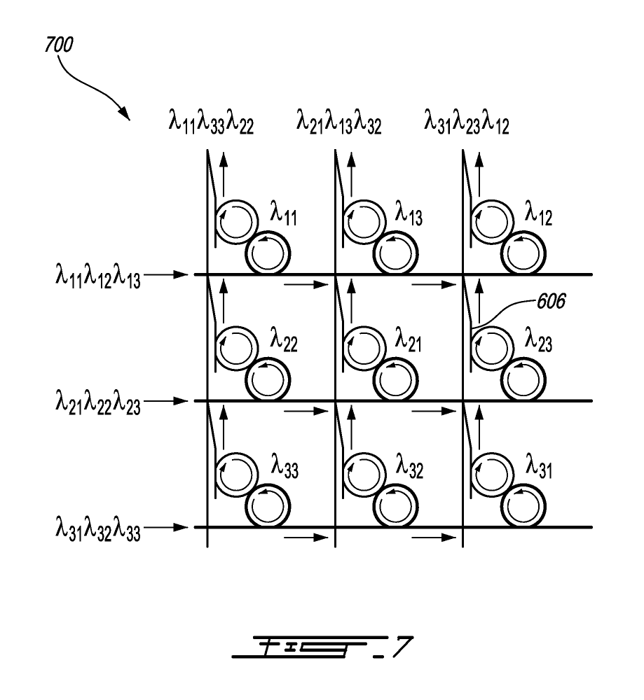

From the foregoing example, it will be appreciated that exemplary embodiments enable the manufacture of an optical crossbar or switch having several ports, each port carrying several optical channels on multiple layers, by placing one device as shown in FIG. 4 at a plurality of waveguide intersection to create an extremely dense component. In FIG. 5, an example of a three-port two-tier micro-ring resonator-based optical crossbar 500 according to an exemplary embodiment is shown. Therein, each of the three ports 102 inputs an optical signal containing three wavelengths or channels. The notation used in FIG. 5 (as well as FIG. 7 below) to represent these wavelengths is λ_{XY}, where X is the port number and Y is the wavelength number. Thus it will be appreciated that in this example, each of the three ports 102 provide an optical signal as an input to the crossbar 500 having the same three wavelengths (albeit potentially carrying different information modulated thereon).

It is desirable to avoid contention between wavelengths or channels which would occur if the same wavelength or channel from two (or more) of the input optical signals were routed onto the same output waveguide toward an output port 104. Accordingly, each of the dual micro-ring resonators 400 disposed at the intersections between input waveguides 106 and output waveguides 108 are selected (or tuned) to extract a wavelength which is different than the wavelengths extracted by the other dual micro-ring resonators 400 which also output light onto the same output waveguide 108 in the second layer.

For example, taking the leftmost output waveguide 108 in FIG. 5, the uppermost dual micro-ring resonator 400 extracts wavelength 1 from the optical signal which it receives from a first input port 102, the middle dual micro-ring resonator 400 extracts wavelength 2 from the optical signal which it receives from a second input port 102, and the bottommost dual micro-ring resonator 400 extracts wavelength 3 from the optical signal which it receives from a third input port. In this exemplary embodiment, the output ports 104 and output waveguides 108 are disposed on an upper layer of the optical crossbar 500, while the input ports 102 and input waveguides 106 are disposed on a lower layer of the optical crossbar 500. The wavelength to which each of the nine dual micro-ring resonators 400 in FIG. 5 are tuned is indicated in a respective “block” by the associated λ_{XY}.

In the foregoing exemplary embodiments of FIGS. 4 and 5, it can be seen that the micro-rings in the dual micro-ring resonators 400 are formed as an integral part of their respective input or output waveguides. Thus, referring now to FIG. 5, most of the micro-rings disposed on the output layer of the optical crossbar 500 receive optical input from both their respective micro-rings on the input layer and from the optical wavelengths which are traveling on the output waveguide 106 of which they are a part. Consider, for example, the dual micro-ring resonator 400 which extracts λ₂₁ in the middle “block” of the crossbar 500. The output layer micro-ring 502 at this intersection receives an optical input from both its respective micro-ring 504 on the input layer, and also an upstream optical input 506 from another dual micro-ring resonator 400. However, it will be appreciated that, at least in typical implementations, optical crossbars do not re-inject optical wavelengths which exit from output ports back into the input waveguides.

This aspect of the foregoing exemplary embodiments is significant since each micro-ring of the dual micro-ring resonator 200, 400 generates typically about a 0.1 dB loss in the optical signal that passes therethrough. Based on the foregoing exemplary embodiments, an optical crossbar or switch 100 is designed such that an incoming waveguide 106 passes through as many dual micro-ring resonators 200, 400 as there are output ports 104. Accordingly, and assuming a 0.1 dB loss per dual micro-ring resonator 200, 400, it can be deduced that a wavelength reaching the extreme end of an incoming waveguide 106 would have lost n times 0.1 dB, once it has reached the n^{th} dual micro-ring resonator 200, 400 corresponding to output port n. Thus, an optical wavelength which travels the longest path on both layers of an optical crossbar, e.g., wavelength λ₃₁ in FIG. 5, will experience a loss of 2n times 0.1 dB.

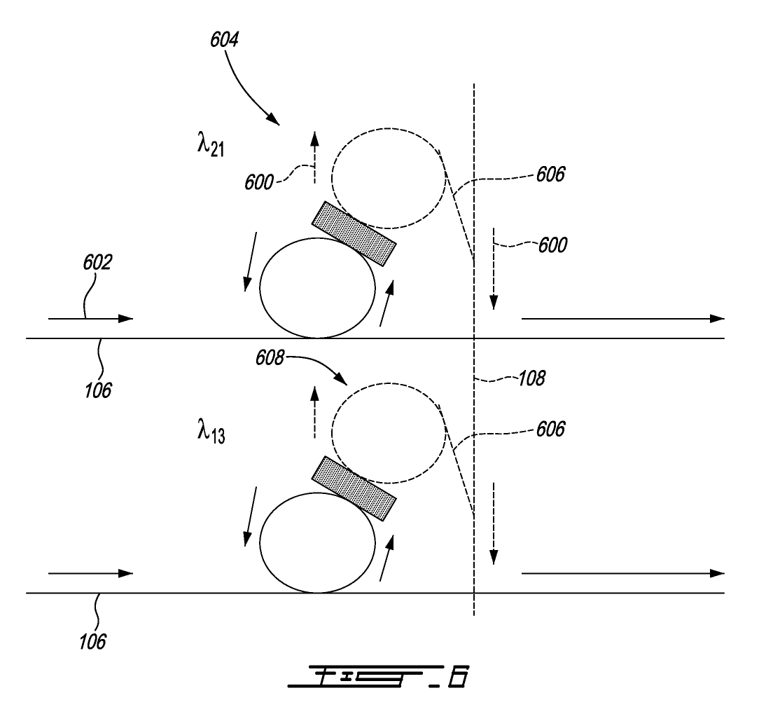

According to another exemplary embodiment, which will now be discussed with respect to FIGS. 6 and 7, the output layer can be built in order to avoid the wavelengths from passing through all of the micro-rings present at the intersections with the input waveguides to reduce this signal loss. FIG. 6 shows this alternative structure for two such intersections. Therein, the portion 600 of the optical signal 602 which has wavelength 1 is extracted by the dual micro-ring resonator 604 and coupled into waveguide 108 by junction 606. The next downstream dual micro-ring resonator 608 also has a similar junction 606 which outputs extracted light, but does not receive (as an optical input) the light portion 600. Thus light portion 600 does not pass through a micro-ring associated with the dual micro-ring resonator 608, unlike the previous exemplary embodiment. In this way, once a wavelength is inserted into an outgoing waveguide 108, it can reach the output port without transiting through any other micro-ring resonators 400, thus reducing optical losses as compared with the previous exemplary embodiment by providing one-way (output only) junctions 606 between the dual micro-ring resonators and their respective output waveguides 108. Stated differently, according to this exemplary embodiment, light only has to pass through one micro-ring on the output layer as compared to the previous exemplary embodiment wherein light may have to pass through as many as n micro-rings, wherein n is the number of output ports. For completeness, FIG. 7 depicts a three port, two-tier dual micro-ring resonator crossbar 700 which is similar to, and operates in the same general manner as, the crossbar 500 except for the usage of one-way output junctions 606 on the output layer.

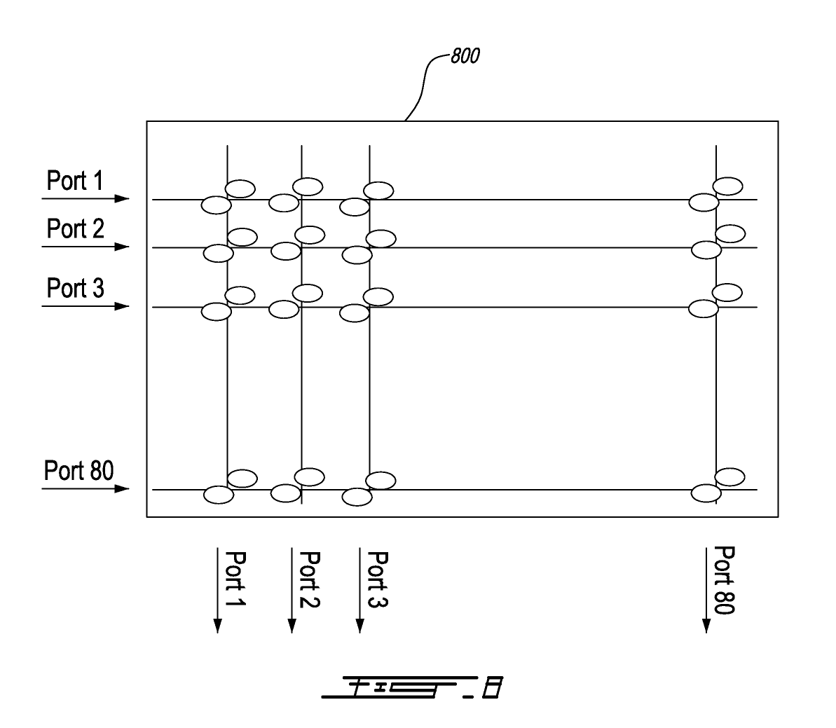

To scale the exemplary embodiment of FIG. 7 into an 80-port crossbar 800, based on 80 incoming and 80 outgoing ports, would typically require 6400 dual-micro-ring resonators 604 as shown conceptually in FIG. 8. Assuming that each dual-resonator introduces a 0.1 DB loss, the worst case would be that one of the optical channels would have to go through a maximum of 80 dual-micro-ring resonators, which corresponds with the maximum number of output ports. This would occur, for example, when one optical channel from port 1 would have to go through 80 micro-rings in the incoming waveguide, before being transferred to the outgoing waveguide of the outgoing port 80. Once in the waveguide of the outgoing port 80, the optical channel can reach the output port without having to go through any extra micro-ring resonators if the exemplary embodiment of FIGS. 6 and 7 is employed. This implies a maximum signal strength loss of approximately 8.1 DB, which is still considered acceptable. In practice, an optical crossbar should be built based on the maximum signal loss that can be tolerated. Then, it would be better to scale the optical crossbar using optical amplifiers.

As explained previously, an optical crossbar according to exemplary embodiments can be built based on a two-tier architecture design. Using the aforedescribed exemplary embodiments, a maximum of one optical channel from an incoming port can be transferred to a specific outgoing port. While this may be sufficient for certain systems, it might be too limited for other systems. Among other things, the capability to redirect several optical channels from a specific input port to a particular output port would allow more flexibility. One possible solution to provide the capability of redirecting more than one optical channel from an input port to an output port could be through an optical crossbar design based on additional layers, i.e., a multi-tier design. According to such an exemplary embodiment, optical channels can be transferred from layer to layer, until the required optical channels can be directed towards the required output port. For example, in the case where ten optical channels from the same input port are to be transferred to the same output port, several layers might be used in order to redirect the optical channels towards the same output port.

In such a multi-tier architecture according to exemplary embodiments, each layer could potentially be oriented in a particular direction, which would allow optical channels to be oriented in a specific direction. Having the control over the direction of the optical channels on each layer, could bring benefits with regards to flexibility. Even though it provides significant flexibility to be able to redirect optical signals between layers, such embodiments would still require that optical signals need to go through several rings, which can involve a significant signal strength loss.

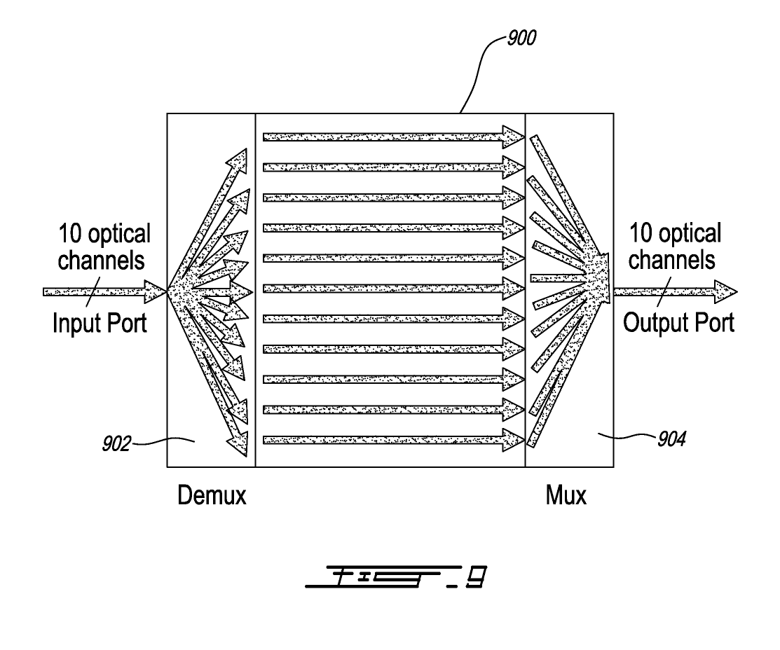

Another approach, to address signal strength loss management, could be based on an architecture where a stack 900 of 2-tier dual-micro-ring resonator crossbars according to exemplary embodiments are provided as shown in FIG. 9. Assuming that each input port can de-multiplex their optical channels efficiently, one specific 2-tier dual-micro-ring resonator crossbar could be dedicated to each optical channel. In other words, in the previous 80-port WDM dual-micro-ring resonator crossbar example, if each input port was carrying 10 optical channels, then a stack of ten 2-tier dual-micro-ring resonator crossbars would be provided. A de-multiplexing stage 902 would be provided on the input port in order to inject a maximum of one optical channel per 2-tier crossbar component. Each 2-tier crossbar component would then redirect the optical channels as usual. However, an extra multiplexing stage 904 would be needed at the output port, in order to merge back the optical channels collected from the different 2-tier crossbar components.

Considering that such a multi-tier dual-micro-ring resonator crossbar can be manufactured as described above, it is expected that such a structure would generate an extremely dense device. Furthermore, a multi-tier crossbar according to this latter exemplary embodiment need not necessarily have the 2-tier dual-micro-ring resonator crossbar elements stacked on top of each other. Alternatively, the elements could be positioned side by side.

The concept of the previous multi-tier crossbar solution is also applicable to ports carrying multiple optical channels using a ribbon-cable. Typically, this means that the same wavelength would be used for each optical channel carried by the port. In such a case, a de-multiplexing stage and a multiplexing stage would be needed. While it can be possible to use the 2-tier dual-micro-ring resonator crossbar design to develop such a crossbar, it would lead to a relatively large number of micro-rings through which optical channels would have to pass in order to allow any incoming optical channel to be redirected to any output port. Accordingly, optical interconnection for signals containing multiple optical channels using the same wavelength is preferably by way of the afore-described multi-tier dual-micro-ring resonator crossbar, or stacked two-tier micro-ring resonator crossbars.

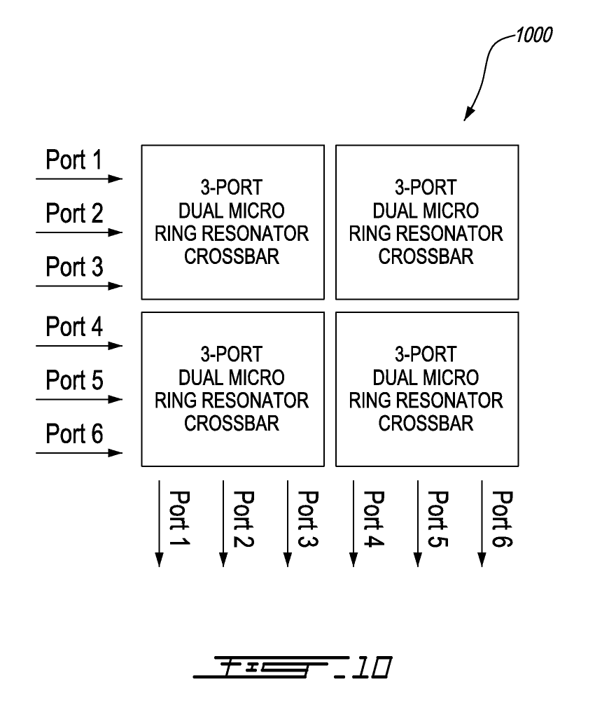

In order to provide better control over the number of ports or optical channels available on dual-micro-ring resonator crossbars according to exemplary embodiments, interconnecting several such dual-micro-ring resonator crossbar components together could be used to build larger networks of optical channels. As shown in FIG. 10, four basic 3-port dual-micro-ring resonator crossbars can be combined in order to provide a full 6-port dual-micro-ring resonator crossbar 1000. This strategy enables the fabrication of large, multiple port, dual-micro-ring resonator crossbars in a manner which is less expensive as they are built from components that can be more easily tested before final assembly. Thus, multiple optical multilayer optical interconnect devices can be connected together according to exemplary embodiments in order to, for example, either (a) horizontally scale a number of said input ports and said output ports or (b) vertically scale a number of wavelengths handled by said optical interconnect system.

Optical devices which are manufactured using the afore-described principles offer a number of potential advantages and benefits. For example, micro-ring resonator technology is currently available for manufacturing products with a very high yield factor. A micro-ring resonator requires an extremely small footprint, is dynamically configurable for transferring any specific wavelength from an input port to an output port, and introduces a relatively low optical attenuation of 0.1 dB per micro-ring. Using micro-ring resonator technology to build a two-tier dual-micro-ring resonator crossbar according to the foregoing exemplary embodiments is advantageous with regards to manufacturing, which allows the crossbar to be developed relatively easily on a PCB. Due to the small space requirement of each micro-ring, a multi-port optical crossbar can be built extremely densely.

Among other things, usage of dual micro-ring resonators according to these exemplary embodiments also makes the solution independent of any mechanical movements, such as the ones involved in MEMS-based solutions. As mechanical movements are more demanding on space and volume, they also require more complexity in manufacturing design. Typically, components requiring mechanical movements imply a certain risk related to reliability, which is not the case for the dual-micro-ring resonators-based components.

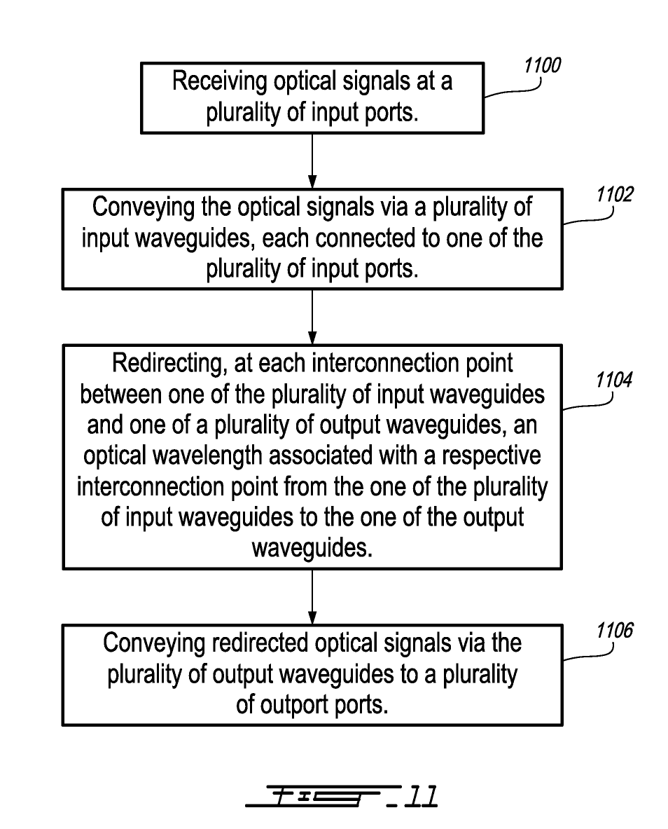

Utilizing the above-described exemplary systems according to exemplary embodiments, a method for conveying optical signals in an optical interconnect is shown in the flowchart of FIG. 11. Therein, at step 1100, optical signals are received at a plurality of input ports. The optical signals are then conveyed, at step 1102, via a plurality of input waveguides, each corresponding to one of the plurality of input ports. At each of a plurality of intersections between one of the plurality of input waveguides and one of a plurality of output waveguides, an optical wavelength associated with a respective intersection is redirected from the one of the plurality of input waveguides to the one of the output waveguides, as shown in step 1104. Then, the redirected optical signals are via the plurality of output waveguides to a plurality of output ports at step 1106.

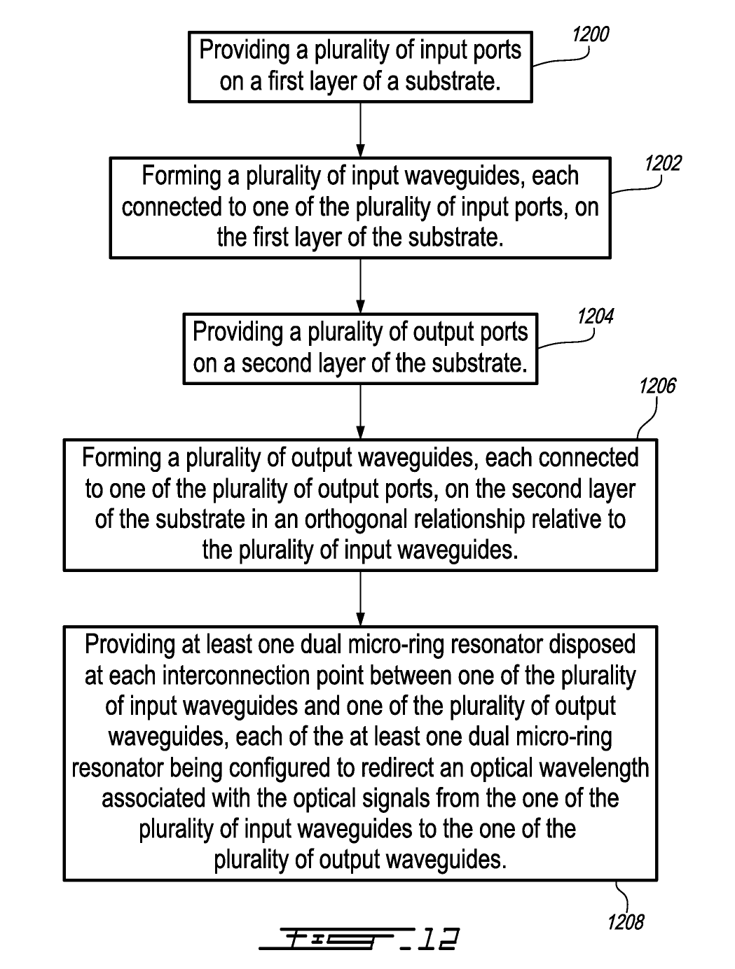

As mentioned above, exemplary embodiments also provide potential advantages in terms of manufacturing. An exemplary method for manufacturing an optical interconnect device is illustrated in the flowchart of FIG. 12. Therein, a plurality of input ports are provided on a first layer of a substrate, e.g., a PCB, at step 1200. A plurality of input waveguides, each corresponding to one of the plurality of input ports, are formed on the first layer of the substrate, at step 1202. At step 1204, a plurality of output ports are provided on a second layer of the substrate. A plurality of output waveguides are formed, each corresponding to one of the plurality of output ports, on the second layer of the substrate in an orthogonal relationship relative to the plurality of input waveguides at step 1206. At least one dual micro-ring resonator disposed at each of a plurality of intersections is provided at step 1208 between one of the plurality of input waveguides and one of the plurality of output waveguides, each of the at least one dual micro-ring resonator being configured to redirect an optical wavelength associated with the optical signals from the one of the plurality of input waveguides to the one of the plurality of output waveguides.

The above-described exemplary embodiments are intended to be illustrative in all respects, rather than restrictive, of the present invention. All such variations and modifications are considered to be within the scope and spirit of the present invention as defined by the following claims. No element, act, or instruction used in the description of the present application should be construed as critical or essential to the invention unless explicitly described as such. Also, as used herein, the article “a” is intended to include one or more items.

What is claimed is:

1. An optical interconnect system comprising:
a multilayer optical interconnect device including:
a plurality of input ports for receiving optical signals;
a plurality of input waveguides, each connected to one of said plurality of input ports, for guiding said optical signals;
a plurality of output ports;
a plurality of output waveguides, each connected to one of said plurality of output ports;
wherein said plurality of input ports and input waveguides are disposed on a first layer of said multilayer optical interconnect device;
wherein said plurality of output ports and output waveguides are disposed on a second layer of said multilayer optical interconnect device;
wherein said plurality of input waveguides and said plurality of output waveguides are disposed on said first and second layers in an orthogonal relationship; and
at least one dual micro-ring resonator disposed at each of a plurality of intersections between said plurality of input waveguides and said plurality of output waveguides, each of said at least one dual micro-ring resonator being configured to redirect an optical wavelength associated with said optical signals from said one of said plurality of input waveguides to said one of said plurality of output waveguides.

2. The multilayer optical interconnect system of claim 1, wherein said at least one dual micro-ring resonator further comprises:
a first micro-ring connected to said one of said plurality of input waveguides;
a second micro-ring connected to said one of said plurality of output waveguides; and
a coupler configured to transfer light having said optical wavelength from said first micro-ring into said second micro-ring.

3. The multilayer optical interconnect system of claim 2, wherein said first micro-ring is disposed on said first layer, said second micro-ring is disposed on said second layer and said coupler is disposed on both said first layer and said second layer of said first multilayer optical interconnect device.

4. The multilayer optical interconnect system of claim 2, wherein said first micro-ring is configured to be a part of said one of said plurality of input waveguides such that said first micro-ring receives an optical input from said one of said plurality of input waveguides; and
wherein said second micro-ring is configured to be a part of said one of said plurality of output waveguides such that said second micro-ring receives optical input from both said first micro-ring and said one of said plurality of output waveguides.

5. The multilayer optical interconnect system of claim 2, wherein said first micro-ring is configured to be a part of said one of said plurality of input waveguides such that said first micro-ring receives an optical input from said one of said plurality of input waveguides; and
wherein said second micro-ring is configured to provide an optical output to said one of said plurality of output waveguides, but only receives optical input from said first micro-ring.

6. The multilayer optical interconnect system of claim 1, wherein said optical wavelength, which is redirected by said at least one dual micro-ring resonator, is configurable.

7. The multilayer optical interconnect system of claim 1, further comprising:
a plurality of said multilayer optical interconnect devices connected to one another in order to either (a) horizontally scale a number of said input ports and said output ports or (b) vertically scale a number of wavelengths handled by said optical interconnect system.

8. A method for conveying optical wavelengths in a multilayer optical interconnect, comprising:
receiving optical signals at a plurality of input ports;
conveying said optical signals via a plurality of input waveguides, each connected to one of said plurality of input ports;
redirecting, at each of a plurality of intersections between one of said plurality of input waveguides and one of a plurality of output waveguides, an optical wavelength from said one of said plurality of input waveguides to said one of said output waveguides; and
conveying redirected optical signals via said plurality of output waveguides to a plurality of output ports,
wherein said plurality of input ports and input waveguides are disposed on a first layer of said multilayer optical interconnect device;
wherein said plurality of output ports and output waveguides are disposed on a second layer of said multilayer optical interconnect device;
wherein said plurality of input waveguides and said plurality of output waveguides are disposed in an orthogonal relationship; and
wherein said step of redirecting is performed by at least one dual micro-ring resonator disposed at each intersection between said one of said plurality of input waveguides and said one of said plurality of output waveguides.

9. The method of claim 8, wherein said at least one dual micro-ring resonator further comprises a first micro-ring connected to said one of said plurality of input waveguides, a second micro-ring connected to said one of said plurality of output waveguides, and a coupler, and wherein said method further comprises:
transferring said optical wavelength associated with said intersection from said first micro-ring into said second micro-ring via said coupler; and
returning a remaining portion of an optical signal in said first micro-ring to said one of said plurality of input waveguides.

10. The method of claim 9, wherein said first micro-ring is disposed on said first layer, said second micro-ring is disposed on said second layer and said coupler is disposed on both said first layer and said second layer of said first multilayer optical interconnect device.

11. The method of claim 9, further comprising:
receiving, at said first micro-ring, an optical input from said one of said plurality of input waveguides; and
receiving, at said second micro-ring optical input from both said first micro-ring and said one of said plurality of output waveguides.

12. The method of claim 9, further comprising:
receiving, at said first micro-ring, an optical input from said one of said plurality of input waveguides; and
receiving, at said second micro-ring, optical input from only said first micro-ring.

13. The method of claim 8, further comprising:
dynamically configuring said optical wavelength which is transferred from said first micro-ring to said second micro-ring.

14. A method for manufacturing an optical interconnect system comprising:
manufacturing a multilayer optical interconnect device by:
providing a plurality of input ports on a first layer of a substrate;
forming a plurality of input waveguides, each connected to one of said plurality of input ports, on said first layer of said substrate;
providing a plurality of output ports on a second layer of said substrate;
forming a plurality of output waveguides, each connected to one of said plurality of output ports, on said second layer of said substrate in an orthogonal relationship relative to said plurality of input waveguides; and
providing at least one dual micro-ring resonator disposed at each of a plurality of intersections between one of said plurality of input waveguides and one of said plurality of output waveguides, each of said at least one dual micro-ring resonator being configured to redirect an optical wavelength associated with said optical signals from said one of said plurality of input waveguides to said one of said plurality of output waveguides.

15. The method of claim 14, wherein said at least one dual micro-ring resonator further comprises:
a first micro-ring connected to said one of said plurality of input waveguides;
a second micro-ring connected to said one of plurality of output waveguides; and
a coupler configured to transfer light having said optical wavelength from said first micro-ring into said second micro-ring.

16. The method of claim 15, wherein said first micro-ring is disposed on said first layer, said second micro-ring is disposed on said second layer and said coupler is disposed on both said first layer and said second layer of said first multilayer optical interconnect device.

17. The method of claim 15, wherein said first micro-ring is configured to be a part of said one of said plurality of input waveguides such that said first micro-ring receives an optical input from said one of said plurality of input waveguides; and
wherein said second micro-ring is configured to be a part of said one of said plurality of output waveguides such that said second micro-ring receives optical input from both said first micro-ring and said one of said plurality of output waveguides.

18. The method of claim 15, wherein said first micro-ring is configured to be a part of said one of said plurality of input waveguides such that said first micro-ring receives an optical input from said one of said plurality of input waveguides; and
wherein said second micro-ring is configured to provide an optical output to said one of said plurality of output waveguides, but only receives optical input from said first micro-ring.

19. The method of claim 14, wherein said optical wavelength, which is redirected by said at least one dual micro-ring resonator, is configurable.

20. The method of claim 14, further comprising:
connecting a plurality of said multilayer optical interconnect devices to one another in order to either (a) horizontally scale a number of said input ports and said output ports or (b) vertically scale a number of wavelengths handled by said optical interconnect system.
